(19) United States
(12) Patent Application Publication
(10) Pub. No.: US 2022/0348141 A1
(43) Pub. Date: Nov. 3, 2022

(54) Vehicle Bumper with Retractable Step

(71) Applicant: Xing Wen LUO, City of Industry, CA (US)

(72) Inventor: Xing Wen LUO, City of Industry, CA (US)

(21) Appl. No.: 17/732,457

(22) Filed: Apr. 28, 2022

(30) Foreign Application Priority Data
Apr. 28, 2021 (CN) 202120908819.3

(51) Int. Cl. B60R 3/02

(52) U.S. Cl. CPC B60R 3/02

(57) ABSTRACT

A vehicle for attaching to a rear end of a vehicle includes a bumper body and a retractable step which includes a mounting base coupled at the bumper body, a step member, and a locking unit. The step member includes a step platform and a swing arm coupled between the mounting base and the step platform. The step member is actuated to move between a retracted position and an extended position. At the retracted position, the swing arm is pivotally and inwardly folded to move the step platform underneath the bumper body, and at the extended position, the swing arm is pivotally and outwardly folded to move the step platform out of the bumper body. The locking unit is arranged to lock up the step member at the retracted position and the extended position.

### CROSS REFERENCE OF RELATED APPLICATION

This application is a non-provisional application that claims the benefit of priority under 35U.S.C.§ 119 to Chinese applications, application number 202120908819.3, filed Apr. 28, 2021, which is incorporated herewith by reference in its entirety.

### BACKGROUND OF THE PRESENT INVENTION

### Field of Invention

The present invention relates to a stepping assist for motor vehicles, and more particularly to a vehicle bumper with a retractable step, which is adapted to move between a retracted position for hiding the retractable vehicle step underneath the vehicle rear bumper and an extended position for providing a step assist into the vehicle.

### Description of Related Arts

Many vehicles, such as sport utility vehicles (SUV), trucks, cargo vans, and pickup trucks, are bigger and taller than normal passenger automobiles. These vehicles are raised off the ground that the ground clearance is raised to make driving over rugged terrain easier. However, some people may have difficulty to get in and out the vehicle due to the raised ground clearance. Furthermore, a roof rack is commonly installed on a roof of the vehicle, especially the SUV, to provide an additional storage space, wherein the bulky or heavy cargo, such as luggage, skis and bicycle, can be fastened at the roof rack on top of the vehicle. Even though this roof rack can well serve for storing items, it is difficult for the people to reach the roof rack for loading and unloading the items at the roof rack. People are required to climb up the roof of the vehicle to access the item carried of fastened the items thereon.

A step assisting device, such as a running board or a nerf bar, is one of the common accessories attached to the bottom of the vehicle, typically at the foot of the door, wherein the step assisting device serves as a step for people entering and existing the vehicle with the raised ground clearance. However, the step assisting device has several drawbacks. Since the step assisting device stick out from beneath of the door of the vehicle to outwardly extend the stepping surface of the step assisting device from the foot of the door, dirt, mud or snow may gather onto the stepping surface, such that the stepping surface will be slippery with the dirt, mud or snow to cause any accident when the people steps on the stepping surface. Furthermore, the step assisting device will affect the ground clearance of the vehicle. One of the main reasons as mentioned above for the people to purchase the vehicle with the raised ground clearance is to make driving over rugged terrain easier. Such vehicle will lower the ground clearance as the normal passenger automobiles when the step assisting device is installed. Since the step assisting device is installed at two sides of the vehicle, people will still unable to reach the roof rack above the trunk area of the vehicle. Some people often think that the step assisting device so dramatically alters the overall look of the vehicle.

### SUMMARY OF THE PRESENT INVENTION

The invention is advantageous in that it provides a vehicle bumper with a retractable step, which is adapted to move between a retracted position for hiding the retractable vehicle step underneath the vehicle rear bumper and an extended position for providing a step assist into the vehicle.

Another advantage of the invention is to provide a vehicle bumper with a retractable step, wherein the retractable step is actuated by a simple and practical single-operation by a user's foot.

Another advantage of the invention is to provide a vehicle bumper with a retractable step, wherein the retractable step is automatically locked at the retracted position and the extended position to prevent any unwanted movement of the retractable step.

Another advantage of the invention is to provide a vehicle bumper with a retractable step, wherein the retractable step is actuated by two continuous actions, i.e. a downward depressing action and forward pushing action, to move from the extended position to the retracted position, and is actuated by one single action, i.e. the downward depressing action, to move from the retracted position to the extended position.

Another advantage of the invention is to provide a vehicle bumper with a retractable step, wherein the retractable step is retained at the retracted position to keep the raised ground clearance of the vehicle and is retained at the extended position to act as a step of the vehicle bumper.

Another advantage of the invention is to provide a vehicle bumper with a retractable step, which is easy to operate by the user's foot in an ergonomically actuating manner to actuate the retractable step between the retracted position and the extended position.

Another advantage of the invention is to provide a vehicle bumper with a retractable step, wherein the retractable step is retained at the retracted position to hide the retractable step underneath the vehicle bumper so as to keep the aesthetic appearance of the vehicle.

Another object of the present invention is to provide a vehicle bumper with a retractable step, which does not require to alter the original structural design of the vehicle bumper so as to minimize the manufacturing cost of the vehicle bumper incorporating with the retractable step.

Another object of the present invention is to provide a vehicle bumper with a retractable step, wherein no expensive or complicated mechanism is required to employ in the vehicle bumper, so that the present invention successfully provides an economic and efficient solution not only for providing a step assist into the vehicle but also for facilitating the practical use of the retractable step.

Additional advantages and features of the invention will become apparent from the description which follows, and may be realized by means of the instrumentalities and combinations particular point out in the appended claims.

According to the present invention, the foregoing and other objects and advantages are attained by a vehicle bumper for attaching to a rear end of a vehicle, comprising a bumper body and a retractable step.

The retractable step, comprises:

at least one mounting bases coupled at a bottom side of the bumper body;

a step member which comprises a step platform and at least a swing arm having a locking portion, an upper end pivotally and slidably coupled at the mounting base and a lower end coupled to the step platform, wherein the step member is actuated to move between a retracted position and an extended position, wherein at the retracted position, the swing arm is pivotally and inwardly folded to move the step platform underneath the bumper body, and at the extended position, the swing arm is pivotally and outwardly folded to move the step platform out of the bumper body; and

a locking unit is arranged to lock up the step member at the retracted position and the extended position.

In accordance with another aspect of the invention, the present invention comprises a retractable step for attaching to a rear bumper of a vehicle, comprising:

at least one mounting bases adapted for coupling at a bottom side of the rear bumper of the vehicle;

a step member which comprises a step platform and at least a swing arm having a locking portion, an upper end pivotally and slidably coupled at the mounting base and a lower end coupled to the step platform, wherein the step member is actuated to move between a retracted position and an extended position, wherein at the retracted position, the swing arm is pivotally and inwardly folded to move the step platform underneath the bumper body, and at the extended position, the swing member is pivotally and outwardly folded to move the step platform out of the bumper body; and

a locking unit is arranged to lock up the step member at the retracted position and the extended position.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a vehicle bumper attaching to a rear end of a vehicle according to a preferred embodiment of the present invention, illustrating a retracted position of a retractable step.

FIG. 2 is a perspective view of the vehicle bumper attaching to the rear end of the vehicle according to the above preferred embodiment of the present invention, illustrating an extended position of the retractable step.

FIG. 3 is a partially perspective view of the vehicle bumper according to the above preferred embodiment of the present invention.

FIG. 3A illustrates an alternative mode of the first resilient element coupled between the first and second arm members according to the above preferred embodiment of the present invention.

FIG. 4 is a partially perspective view of the vehicle bumper according to the above preferred embodiment of the present invention, illustrating the swing arm being locked by the locking unit at the extended portion.

FIG. 4A is a partially perspective view of the vehicle bumper according to the above preferred embodiment of the present invention, illustrating the rear foot pressing platform coupled at the lower end of the second arm member.

FIG. 5 is schematic diagram of the vehicle bumper according to the above preferred embodiment of the present invention, illustrating the retractable step being moved from the extended position to the retracted position.

FIG. 6 is schematic diagram of the vehicle bumper according to the above preferred embodiment of the present invention, illustrating the retractable step being moved from the retracted position to the extended position.

FIG. 7 is a front perspective view of a retractable step of a vehicle bumper according to a second preferred embodiment of the present invention.

FIG. 8 is a rear perspective view of the retractable step of the vehicle bumper according to the second preferred embodiment of the present invention.

FIG. 9 is schematic diagram of the vehicle bumper according to the second preferred embodiment of the present invention, illustrating the retractable step being moved from the extended position to the retracted position.

FIG. 10 is schematic diagram of the vehicle bumper according to the second preferred embodiment of the present invention, illustrating the retractable step being moved from the retracted position to the extended position.

FIG. 11 is a perspective view of a vehicle bumper according to a third preferred embodiment of the present invention.

FIG. 12 is a perspective view of a vehicle bumper according to a fourth preferred embodiment of the present invention.

FIG. 13 is a perspective view of a vehicle bumper according to a fifth preferred embodiment of the present invention.

FIG. 14 is perspective view of a retractable step of the vehicle bumper according to the fifth preferred embodiment of the present invention, illustrating the retractable step being moved between the retracted position and the extended position.

FIG. 15 is a perspective view of a vehicle bumper according to a sixth preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

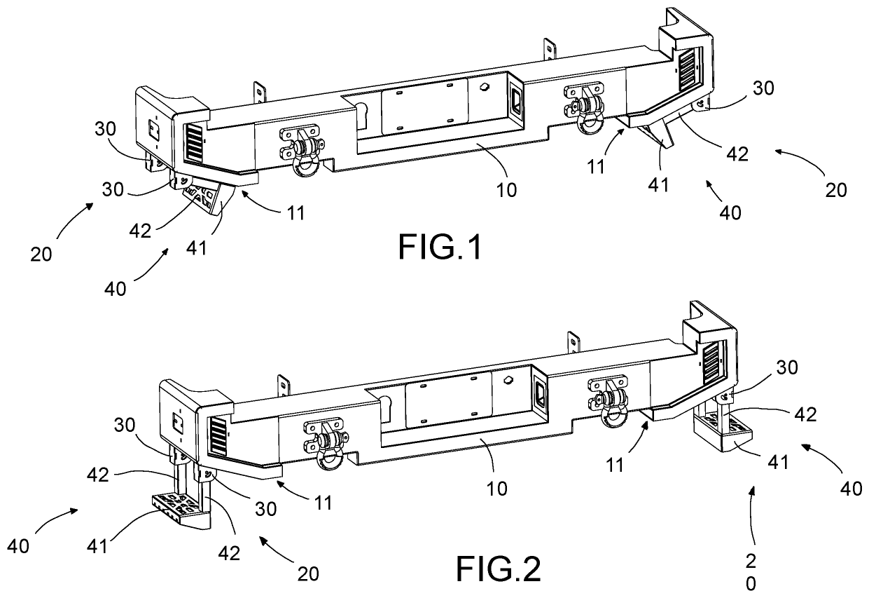

Referring to FIGS. 1 to 3 of the drawings, a vehicle bumper according to a preferred embodiment of the present invention is illustrated, wherein the vehicle bumper is arranged for attaching to a vehicle. The vehicle bumper comprises a bumper body 10 and at least one retractable step 20.

As shown in FIGS. 1 and 2, the bumper body 10 has an elongated structure arranged to transversely mount at a front end or rear end of the vehicle. According to the preferred embodiment, the bumper body 10 is embodied as a rear bumper arranged for attaching to the rear end of the vehicle. The bumper body 10 has a mid-portion and two side end portions sidewardly extended from the mid-portion, wherein the bumper body 10 further has a bottom side 11 defined at the mid-portion and the side end portions of the bumper body 10.

The retractable step 20 comprises at least one mounting base 30 coupled at the bottom side 11 of the bumper body 10, a step member 40 supported below the bottom side 11 of the bumper body 10, and a locking unit 50. As shown in FIGS. 1 and 2, two retractable steps 20 are coupled at the bottom sides 11 of the side end portions of the bumper body 10 respectively. It is appreciated that one retractable step 20 can be selectively coupled at the bottom side 11 of the bumper body 10 at one of the mid-portion and the side end portions thereof.

The step member 40 comprises a step platform 41 and at least one swing arm 42 coupled between the mounting base 30 and the step platform 41. The step member 40 is actuated to move between a retracted position and an extended position. At the retracted position, as shown in FIG. 1, the swing arm 42 is pivotally and inwardly folded to move the step platform 41 underneath the bumper body 10. At the extended position, as shown in FIG. 2, the swing arm 41 is pivotally and outwardly folded to move the step platform 41 out of the bumper body 10. Preferably, the bottom side 11 of the side end portion of the bumper body 10 is a slanted surface upwardly and outwardly extended toward an end of the bumper body 10, such that step member 40 is sidewardly and pivotally moved between the retracted position and the extended position relative to the bumper body 10.

The locking unit 50 is arranged to lock up the step member 40 at the retracted position and the extended position.

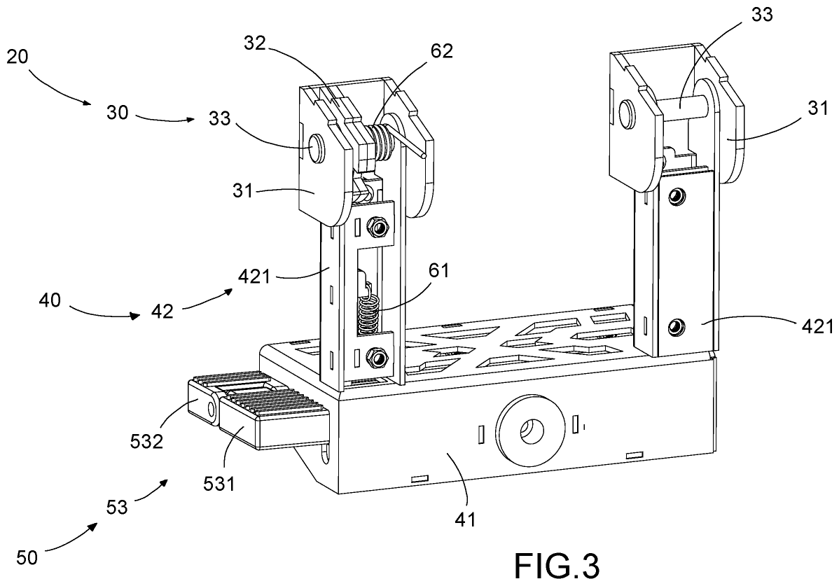

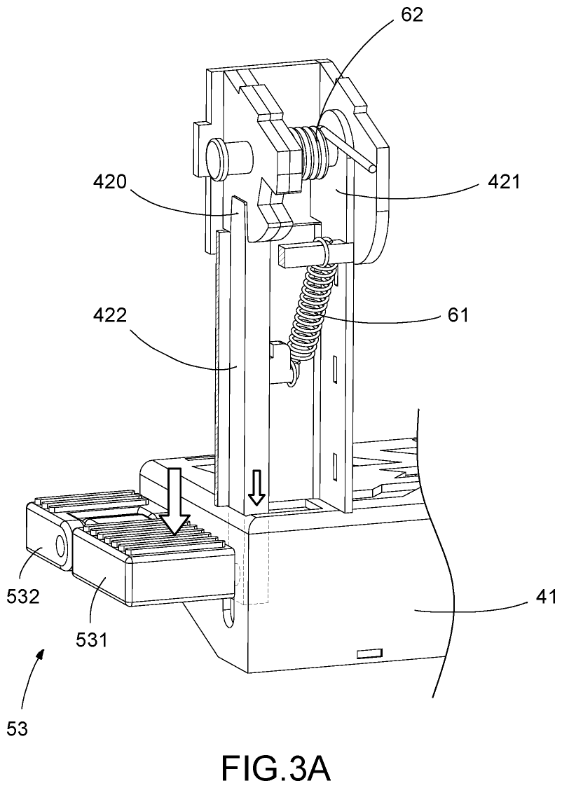

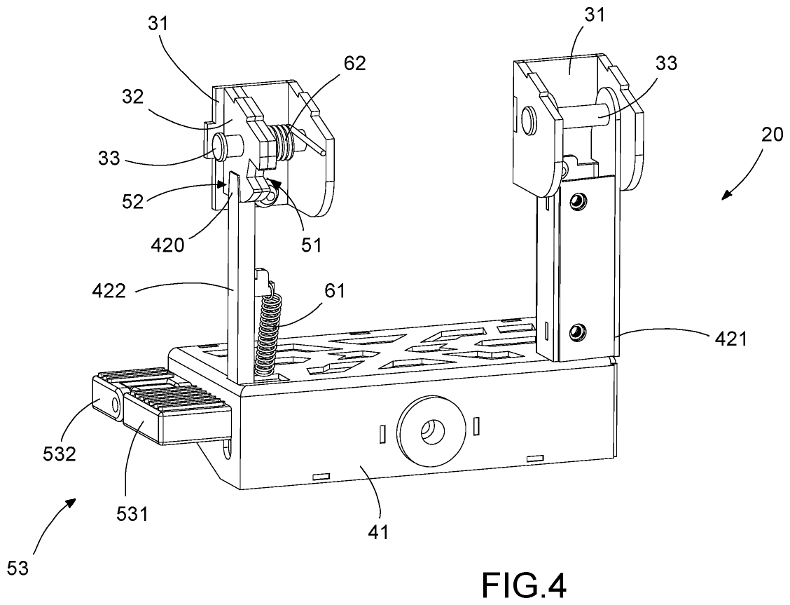

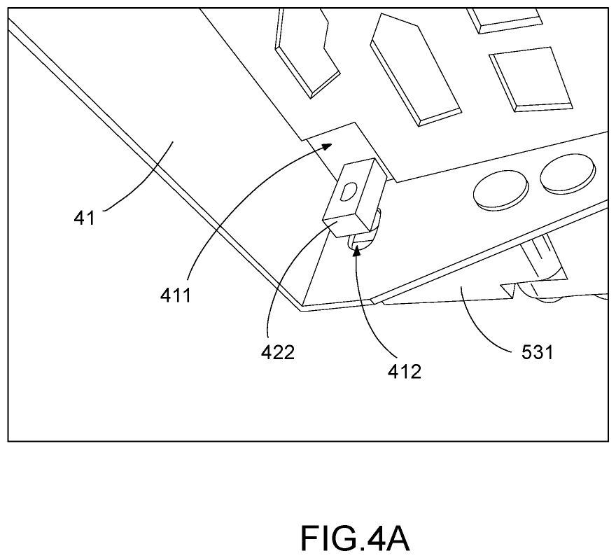

As shown in FIGS. 3 and 4, two mounting bases 30 are provided to spacedly mount at the bottom side 11 of the bumper body 10 to support the step member 40. Each of the mounting bases 30 comprises a U-shaped base member 31 coupled at the bottom side 11 of the bumper body 10, a mounting plate 32 supported in the base member 30, and a pivot shaft 33. The U-shaped base member 31 has a base portion coupled at the bottom side 11 of the bumper body 10 and two wing portions, wherein the pivot shaft 33 is extended between the wing portions of the base member 31 through the mounting plate 32 so as to support the mounting plate 32 between the wing portions of the base member 30.

As shown in FIGS. 3 and 4, two swing arms 42 are coupled between the mounting bases 30 and the step platform 41. Particularly, two upper ends of the swing arms 42 are pivotally and slidably coupled at the mounting bases 30 respectively while two lower ends of the swing arms 42 are coupled at the step platform 41 at two sides thereof respectively. Accordingly, the swing arm 42 further has a locking portion 420 arranged to releasably engage with the locking unit 50 so as to lock up the step member 20 at either the retracted position or the extended position.

The locking unit 50 comprises a first engagement element 51 and a second engagement element 52 formed at the mounting base 30 and spaced apart with each other, wherein the locking portion 420 of the swing arm 42 is selectively moved to engage with the first engagement element 51 so as to lock up the step member 40 at the retracted position and to engaged with the second engagement element 52 so as to lock up the step member 40 at the extended position.

According to the preferred embodiment, the first and second engagement elements 51, 52 are first and second engagement slots spacedly indented at a circumferential edge of the mounting base 30 for engaging with the locking portion 420 of the swing arm 42. Particularly, the first and second engagement slots of the first and second engagement elements 51, 52 are spacedly indented at a circumferential edge of the mounting plate 32 of the mounting base 30, wherein the first and second engagement slots are radially extended from the circumferential edge of the mounting plate 32 with respect to the pivot shaft 33.

The swing arm 42 is slidably and downwardly moved away from the mounting base 30 to disengage the locking portion 420 of the swing arm 42 with one of the first and second engagement elements 51, 52 in order to pivotally fold the swing arm 42 to move between the retracted position and the extended position.

As shown in FIGS. 3 and 4, the swing arm 420 has a telescopic configuration to selectively adjust its length. The swing arm 420 comprises a first arm member 421 having an upper end pivotally coupled at the mounting base 30, and a second arm member 422 having a lower end extended to the step platform 41. Accordingly, the upper end of the first arm member 421 is pivotally coupled between the wing portions of the base member 31 via the pivot shaft 33, such that the upper end of the first arm member 421 are located side-by-side of the mounting plate 32. Preferably, the first arm member 421 has a tubular configuration, wherein the second arm member 422 is slidably received within the first arm member 422. As shown in FIG. 4, the second arm member 422 is a solid member.

According to the preferred embodiment, the first arm member 521 and the second arm member 522 are slidably coupled with each other, wherein the locking portion 420 of the swing arm 42 is defined at an upper end of the second arm member 422, such that when the second arm member 422 is downwardly slid from the first arm member 421 to downwardly move away from the mounting base 30, the locking portion 420 of the second arm member 422 is disengaged with one of the first and second engagement elements 51, 52.

In one embodiment, the locking portion 420 of the swing arm 42 is an engaging protrusion integrally extended from the swing arm 42 to selectively engage with one of the first and second engagement slots 51, 52. Accordingly, the engaging protrusion of the locking portion 42 is integrally formed at the upper end of the second arm member 422, wherein when the second arm member 422 is downwardly slid from the first arm member 421, the engaging protrusion of the second arm member 422 is driven to disengage with one of the first and second engagement slots 51, 52. When the second arm member 422 is upwardly slid at the first arm member 421, the engaging protrusion of the second arm member 422 is driven to engage with one of the first and second engagement slots 51, 52. In other words, a downward displacement of the second arm member 422 with respect to the first arm member 421 matches with the height of the engaging protrusion to be disengaged with one of the first and second engagement slots 51, 52. It is worth mentioning that the engaging protrusion is inserted into the first engagement slot 51 to lock up the step member 40 in the retracted position and is inserted into the second engagement slot 52 to lock up the step member 40 in the extended position.

It is worth mentioning that when the locking portion 420 of the swing arm 42 is engaged with one of the first and second engagement slots 51, 52, the swing arm 42 is locked to prevent any pivotal movement of the swing arm 42. Once the locking portion 420 of the swing arm 42 is disengaged with one of the first and second engagement slots 51, 52, the swing arm 42 is unlocked to enable the pivotal movement of the swing arm 42 so as to allow the step member 40 to move between the retracted position and the extended position.

According to the preferred embodiment, the retractable step 20 further comprises a first resilient element 61 coupled between the first and second arm members 421, 422 for applying a pulling force between the first and second arm members 421, 422 so as to ensure the locking portion 420 being engaged with one of the first and second engagement elements 51, 52. In one embodiment, the first resilient element 61 comprises a compression spring having one end connecting to the first arm member 421 and an opposed end connecting to the second arm member 422 for pulling the first and second arm members 421, 422 toward each other. Particularly, a lower end of the first resilient element 61 is connected to the first arm member 421 while an upper end of the first resilient element 61 is connected to the second arm member 422. In other words, when a downward pulling force is applied to the second arm member 422 to downwardly slide at the first arm member 421, the first resilient element 61 is pulled to stretch to prolong its length while the locking portion 420 is disengaged with one of the first and second engagement elements 51, 52. Once the downward pulling force is released from the second arm member 422, the first resilient element 61 is arranged to return back to its original form to apply a spring pulling force as a first restoring force for pulling the second arm member 422 to the first arm member 421 so as to ensure the locking portion 420 being engaged with one of the first and second engagement elements 51, 52.

FIG. 3A illustrates an alternative mode of the first resilient element 61 coupled between the first and second arm members 421, 422 for applying a pulling force between the first and second arm members 421, 422. In this alternative mode, the first resilient element 61 comprises a compression spring having one end connecting to the first arm member 421 and an opposed end connecting to the second arm member 422 for pulling the first and second arm members 421, 422 toward each other. Particularly, an upper end of the first resilient element 61 is connected to the first arm member 421 while a lower end of the first resilient element 61 is connected to the second arm member 422.

The retractable step 20 further comprises a second resilient element 62 coupled between the mounting base 30 and the first arm member 421 for applying a pushing force to the swing arm 42 to pivotally push the step member 40 from the retracted position to the extended position when the locking portion 420 is disengaged with the first engagement element 51.

As shown in FIGS. 3 and 4, the second resilient element 62 comprises a coil spring having a coil portion and two arm portions. The coil portion of the second resilient element 62 coupled at a pivot point between the first arm member 421 and the mounting base 30. Particularly, the coil portion of the second resilient element 62 is coaxially mounted at the pivot shaft 33 of the mounting base 30 as the pivot point thereof, such that the second resilient element 62 is located between two wing portions of the base member 31. The two arm portions of the second resilient element 62 are configured for biasing against the mounting base 30 and the first arm member 421 respectively for pushing the swing arm 42 from the retracted position to the extended position. It is worth mentioning that the second resilient element 62 is only apply a coil spring force to push the step member 40 from the retracted position to the extended position. In other words, when the step member 40 from the extended position to the retracted position, the two arm portions of the second resilient element 62 are pressed toward each other. Therefore, the second resilient element 62 is arranged to apply the coil spring force as a second restoring force to push the step member 40 from the retracted position to the extended position.

As shown in FIGS. 3 and 4, the locking unit 50 further comprises a foot actuator 53 sidewardly extended from the step platform 41 in order to disengage the locking portion 420 of the swing arm 42 from each of the first and second engagement elements 41, 42 and pivotally push the swing arm 42 from the extended position to the retracted position. According to the preferred embodiment, the user's foot is able to press on the foot actuator 53 in order to unlock the step member 40. Particularly, the foot actuator 53 is coupled at the lower end of the second arm member 422, such that when the foot actuator 53 is pressed downwardly, the second arm member 422 is downwardly slid with respect to the first arm member 421 to disengage the locking portion 420 with one of the first and second engagement element 51, 52.

According to the preferred embodiment, the foot actuator 53 comprises a rear foot pressing platform 531 coupled at the lower end of the second arm member 422 and a front foot pushing platform 532 pivotally coupled at a front edge of the rear foot pressing platform 531 for pushing the step member 41 from the extended position to the retracted position. Accordingly, since the foot actuator 53 is actuated by the user's foot, the foot actuator 53 must be designed ergonomically for the foot movement of the user. The user's foot is able to downwardly press on the rear foot pressing platform 531 to unlock the swing arm 42. Then, the user's foot is able to push the front foot pushing platform 532 to move the step member 40 under the bottom side 11 of the bumper body 10. The front foot pushing platform 532 is pivotally and downwardly moved from the rear foot pressing platform 531 in order for the user's foot easily steps on the front foot pushing platform 532 to apply the pushing force at the step member 40.

As shown in FIG. 4A, the step member 41 has a top through slot 411 formed on a top surface of the step member 41 and a side through slot 412 formed at a side surface of the step member 41, wherein the lower end of the second arm member 422 is downwardly extended to a bottom surface of the step member 41 through the top through slot 411. The rear foot pressing platform 531 has a side extension extended through the side through slot 412 to the bottom surface of the step member 41 so as to operatively couple to the lower end of the second arm member 422, such that when the rear foot pressing platform 531 is downwardly pressed, the second arm member 422 is driven to slid downwardly to unlock the swing arm 42 for moving the step member 40 under the bottom side 11 of the bumper body 10.

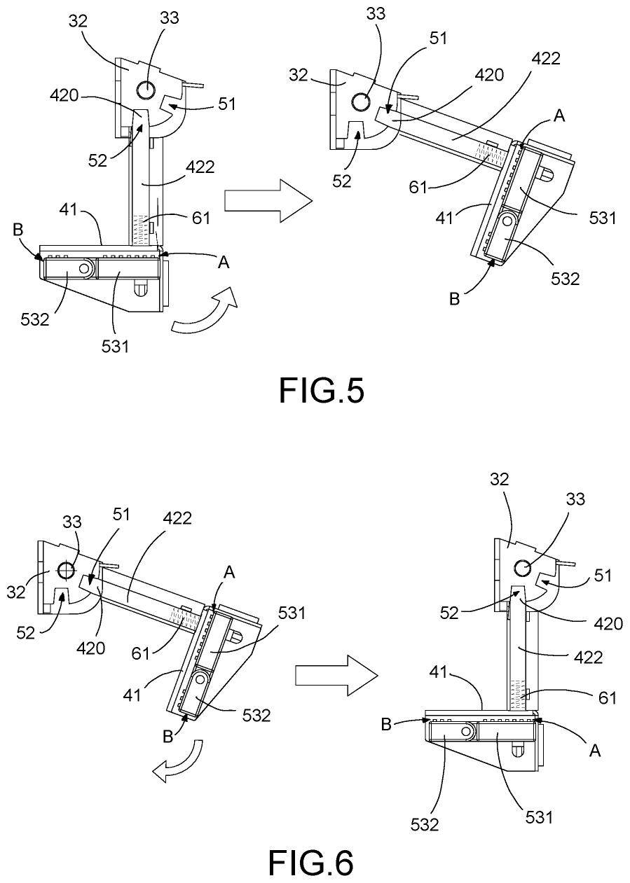

In order to move the step member 40 from the extended position to the retracted position, as shown in FIG. 5, the user is able to step on the rear foot pressing platform 531 to apply a downward force at point A. Then, the second arm member 422 is slid downwardly to disengage the locking portion 420 with the second engagement element 52 to unlock the step member 40. Once the step member 40 is unlocked in the extended position, the user is able to step on the front foot pushing platform 532 to apply a pushing force at point B. Then, the second arm member 422 of the swing arm 42 is pivotally and rearwardly moved until the locking portion 420 with the first engagement element 51 by the first restoring force, i.e. the spring force, of the first resilient element 61 so as to lock the step member 40 in the retracted position. Therefore, the user requires two continuous actions, i.e. press and push actions, in one single motion to move the step member 40 from the extended position to the retracted position.

In order to move the step member 40 from the retracted position to the extended position, as shown in FIG. 6, the user is able to step on the rear foot pressing platform 531 to apply a downward force at point A. Then, the second arm member 422 is slid downwardly to disengage the locking portion 420 with the first engagement element 51 to unlock the step member 40. Once the step member 40 is unlocked in the retracted position, the second resilient element 62 will apply the second restoring force, i.e. the coil spring force, to the second arm member 422. Then, the second arm member 422 of the swing arm 42 is pivotally and frontwardly moved until the locking portion 420 with the second engagement element 52 by the first restoring force, i.e. the spring force, of the first resilient element 61 so as to lock the step member 40 in the extended position. Therefore, the user requires only one single action, i.e. the press action, in one single motion to move the step member 40 from the retracted position to the extended position.

Preferably, two swing arms 42 are provided to rigidly support the step platform 41 for supporting the weight of the user when the user steps on the step platform 41. Preferably, the two swing arms 42 are identical that when the foot actuator 53 is downwardly pressed, the second arm members 422 of the swing arms 42 are concurrently slid downward to disengage the locking portions 420 of the swing arms 42 with the first engagement members 51 at the same time to move the step member 40 from the retracted position to the extended position. Likewise, the second arm members 422 of the swing arms 42 are concurrently slid downward to disengage the locking portions 420 of the swing arms 42 with the second engagement members 52 at the same time to move the step member 40 from the extended position to the retracted position. Alternatively, one of the swing arms 42 serves as a supporting arm which has an upper end pivotally coupled to the mounting base 30 and a lower end coupled to the step platform 41. In other words, the foot actuator 53 is downwardly pressed to actuate the swing arm 42 only while the supporting arm assists the swing arm to move between the retracted position and the extended position.

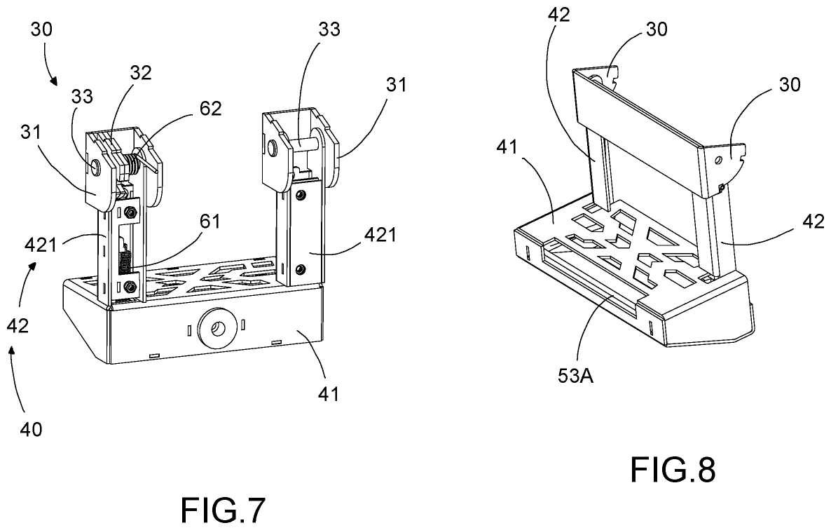

As shown in FIGS. 7 and 8, a vehicle bumper according to a second embodiment illustrates an alternative mode of the above first embodiment of the present invention, wherein the structural configurations of the bumper body 10 and the retractable step 20 of the second embodiment are the same as these in the first embodiment. In other words, the second embodiment illustrates an alternative mode of the locking unit 50A of the first embodiment.

According to the second embodiment, the locking unit 50A, which is arranged to lock up the step member 40 at the retracted position and the extended position, has the similar structure as mentioned in the first embodiment, except the foot actuator 53A. As shown in FIGS. 7 to 10, the foot actuator 53A is extended underneath the step platform 41 in order to disengage the locking portion 420 of the swing arm 42 from each of the first and second engagement elements 41, 42 and pivotally push the swing arm 42 from the extended position to the retracted position. Particularly, a front tip portion of the foot actuator 53A is frontwardly protruded from a front side of the step member 40, such that the user is able to press on the front tip portion of the foot actuator 53A.

According to the second embodiment, the user's foot is able to press on the front tip portion of the foot actuator 53A in order to unlock the step member 40. Particularly, the foot actuator 53A is coupled at the lower end of the second arm member 422, such that when the foot actuator 53 is pressed downwardly, the second arm member 422 is downwardly slid with respect to the first arm member 421 to disengage the locking portion 420 with one of the first and second engagement element 41, 42.

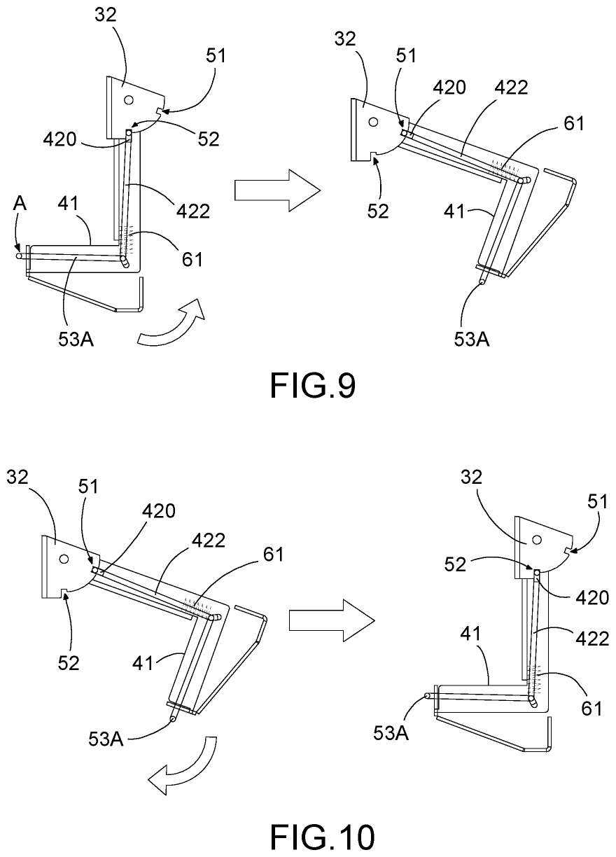

In order to move the step member 40 from the extended position to the retracted position, as shown in FIG. 9, the user is able to step on the front tip portion of the foot actuator 53A to apply a downward force at point A. Then, the second arm member 422 is slid downwardly to disengage the locking portion 420 with the second engagement element 52 to unlock the step member 40. Once the step member 40 is unlocked in the extended position, the user is able to step on the foot actuator 53A to apply a pushing force at point A. Then, the second arm member 422 of the swing arm 42 is pivotally and rearwardly moved until the locking portion 420 with the first engagement element 51 by the first restoring force, i.e. the spring force, of the first resilient element 61 so as to lock the step member 40 in the retracted position. Therefore, the user requires two continuous actions, i.e. press and push actions, in one single motion to move the step member 40 from the extended position to the retracted position.

In order to move the step member 40 from the retracted position to the extended position, as shown in FIG. 10, the user is able to step on the front tip portion of the foot actuator 53A to apply a downward force at point A. Then, the second arm member 422 is slid downwardly to disengage the locking portion 420 with the first engagement element 51 to unlock the step member 40. Once the step member 40 is unlocked in the retracted position, the second resilient element 62 will apply the second restoring force, i.e. the coil spring force, to the second arm member 422. Then, the second arm member 422 of the swing arm 42 is pivotally and frontwardly moved until the locking portion 420 with the second engagement element 52 by the first restoring force, i.e. the spring force, of the first resilient element 61 so as to lock the step member 40 in the extended position. Therefore, the user requires only one single action, i.e. the press action, in one single motion to move the step member 40 from the retracted position to the extended position.

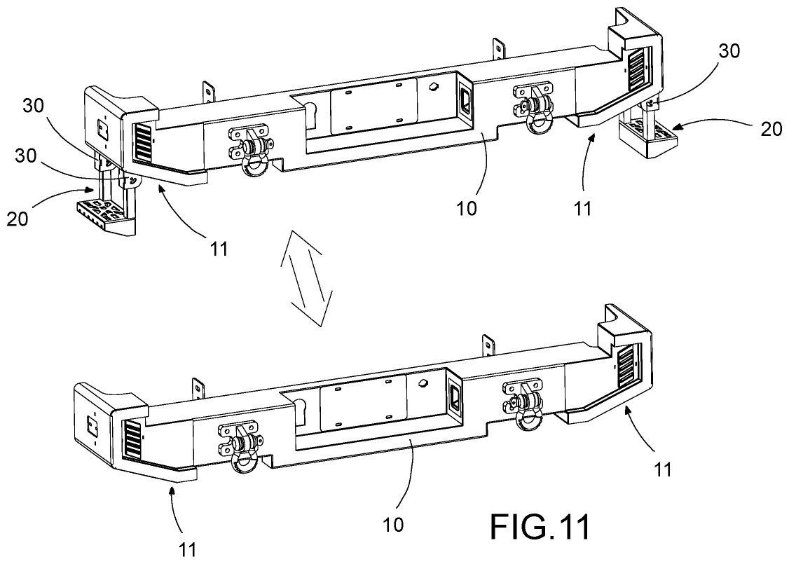

As shown in FIG. 11, a vehicle bumper according to a third embodiment illustrates an alternative mode of the above first embodiment of the present invention, wherein the structural configuration of the vehicle bumper of the third embodiment is the same as that in the first embodiment. The difference between the first embodiment and the third embodiment is that the mounting base 30 is detachably coupled at the bottom side 11 of the bumper body 10. In other words, at the extended position, the retractable step 20 is coupled at the bottom side 11 of the bumper body 10 by coupling the mounting base 30 thereat. At the retracted position, the retractable step 20 is removed from the bottom side 11 of the bumper body 10 by detaching the mounting base 30 thereat. It is worth mentioning that the mounting base 30 is detachably coupled at the bottom side 11 of the bumper body 10 via a quick connector such as a hand screw.

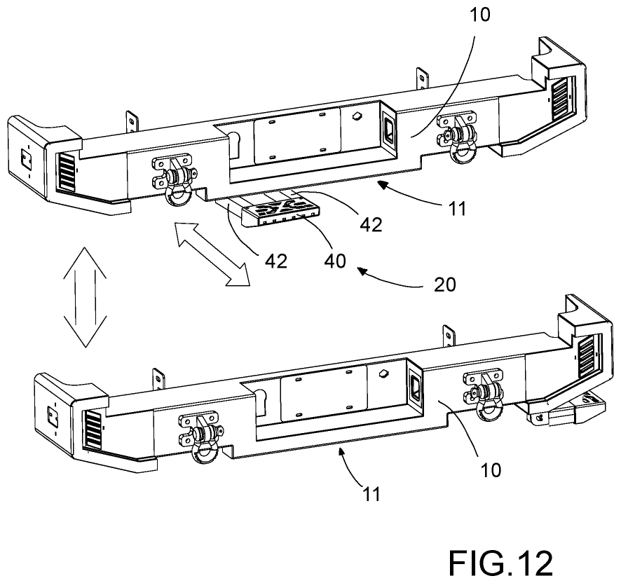

As shown in FIG. 12, a vehicle bumper according to a fourth embodiment illustrates an alternative mode of the above first embodiment of the present invention, wherein the structural configuration of the vehicle bumper of the fourth embodiment is the same as that in the first embodiment. The difference between the first embodiment and the fourth embodiment is that the retractable step 20 is slidably coupled at the bottom side 11 of the bumper body 10 in an outward direction. Accordingly, the retractable step 20 is slidably coupled at the bottom side 11 of the bumper body 10 to slide between the retracted position and the extended position. Accordingly, two swing arms 42 are slidably coupled at the bottom side 11 of the bumper body 10. Therefore, at the extended position, the step member 40 is slid out of the bottom side 11 of the bumper body 10. At the retracted position, the step member 40 is slid under the bottom side 11 of the bumper body 10 in a hidden manner.

It is worth mentioning that the retractable step 20 can be mounted at the mid-portion and/or side end portion of the bumper body 10 at the bottom side 11 thereof as shown in FIG. 12.

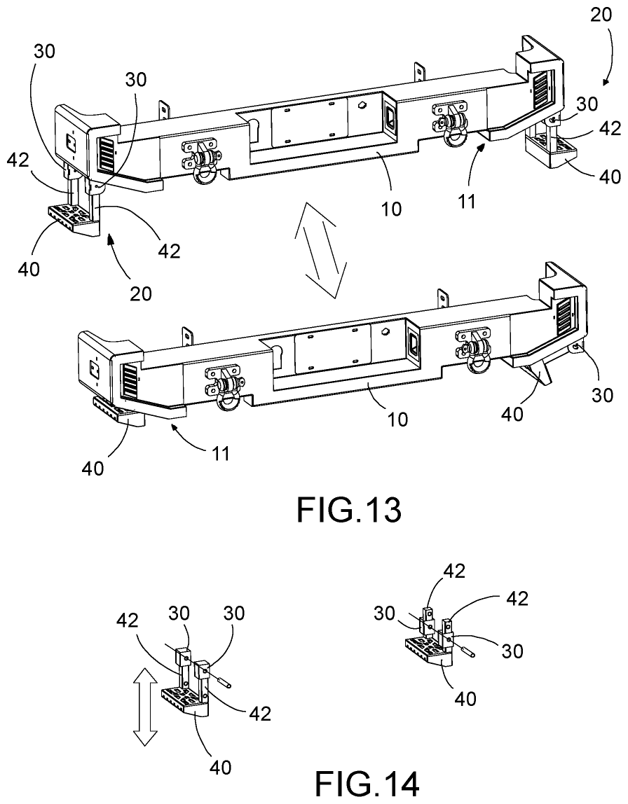

As shown in FIG. 13, a vehicle bumper according to a fifth embodiment illustrates an alternative mode of the above fourth embodiment of the present invention, wherein the structural configuration of the vehicle bumper of the fifth embodiment is the same as that in the fourth embodiment. The difference between the fourth embodiment and the fifth embodiment is that the retractable step 20 is slidably coupled at the bottom side 11 of the bumper body 10 in a downward direction. Accordingly, the mounting base 30 is securely coupled at the bottom side 11 of the bumper body 10, wherein the retractable step 20 is slidably coupled to the mounting base 30 to slide between the retracted position and the extended position.

As shown in FIGS. 13 and 14, two mounting bases 30 are coupled at the bottom side 11 of the bumper body 10, wherein each of the mounting bases 30 has a hollow structure, such that two swing arms 42 are slidably coupled through the mounting bases 30 respectively. Therefore, at the extended position, the swing arms 42 are downwardly slid at the mounting bases 30, such that the step member 40 is slid down from the bottom side 11 of the bumper body 10. At the retracted position, the swing arms 42 are upwardly slid at the mounting bases 30, such that the step member 40 is slid upwardly to the bottom side 11 of the bumper body 10 in a hidden manner.

It is worth mentioning that different configurations of the retractable steps 20 can be mounted at the bottom side 11 of the bumper body 10 as shown in FIG. 13. The retractable step 20 with downward sliding operation of the fifth embodiment can be coupled at one side end portion of the bumper body 10 while the retractable step 20 with inward pivoting operation of the first embodiment can be coupled at another side end portion of the bumper body 10.

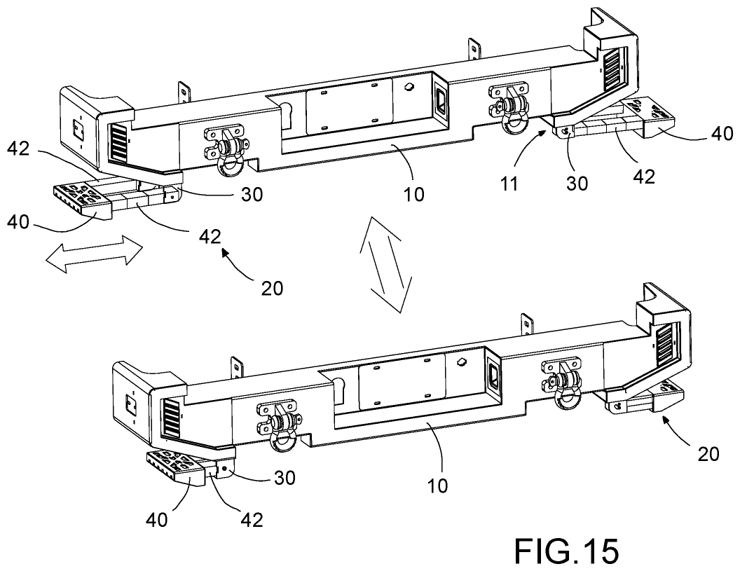

As shown in FIG. 15, a vehicle bumper according to a sixth embodiment illustrates an alternative mode of the above fourth embodiment of the present invention, wherein the structural configuration of the vehicle bumper of the sixth embodiment is the same as that in the fourth embodiment. The difference between the fourth embodiment and the sixth embodiment is that the retractable step 20 has a retractable feature. Accordingly, the mounting base 30 is securely coupled at the bottom side 11 of the bumper body 10, wherein the retractable step 20 is retractably coupled to the mounting base 30 to slide between the retracted position and the extended position.

According to the sixth embodiment, two mounting bases 30 are coupled at the bottom side 11 of the bumper body 10, wherein two swing arms 42 are coupled to the mounting bases 30 respectively. Each of the swing arms 42 has a telescopic structure to form a telescopic arm coupled between the mounting base 30 and the step member 40, such that each of the swing arms 42 is adapted to selectively adjust its length to move the step member 40 between the retracted position and the extended position. Therefore, at the extended position, the length of each of the swing arms 42 is prolonged to move the step member 40 out of the bottom side 11 of the bumper body 10. At the retracted position, the length of each of the swing arms 42 is reduced to move the step member 40 under the bottom side 11 of the bumper body 10.

According to the preferred embodiment, the location of the foot actuator 53 should not be limited. In one embodiment, the foot actuator 53 is sidewardly extended from the step platform 41 either the right side or left side thereof. Alternatively, the foot actuator 53 can be spacedly located underneath the step platform 41, such that the user can place his or her foot under the step platform 41 to step on the foot actuator 53. In other words, when the step member 40 is locked at the extended position, the user is able to step on the step platform 41 for providing a step assist into the vehicle without accidently unlock the step member 40. The retractable step 20 can be hidden under the bumper body 10 when it is not in use.

According to the preferred embodiment, the retractable step 20 can be mounted at any existing vehicle bumper to provide a step assisting device for the vehicle. The retractable step 20 can also couple at a side of the vehicle to serve as a step platform for the user to get in and out of the vehicle.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A vehicle bumper for attaching to a rear end of a vehicle, comprising:
a bumper body having a bottom side; and
a retractable step which comprises:
at least one mounting bases coupled at said bottom side of said bumper body;
a step member which comprises a step platform and at least a swing arm having a locking portion, an upper end pivotally and slidably coupled at said mounting base and a lower end coupled to said step platform, wherein said step member is actuated to move between a retracted position and an extended position, wherein at said retracted position, said swing arm is pivotally and inwardly folded to move said step platform underneath said bumper body, and at said extended position, said swing arm is pivotally and outwardly folded to move said step platform out of said bumper body; and
a locking unit which comprises a first engagement element and a second engagement element formed at said mounting base and spaced apart with each other, wherein said locking portion of said swing arm is selectively moved to engage with said first engagement element so as to lock up said step member at said retracted position and to engaged with said second engagement element so as to lock up said step member at said extended position.

2. The vehicle bumper, as recited in claim 1, wherein said swing arm is slidably and downwardly moved away from said mounting base to disengage said locking portion of said swing arm with one of said first and second engagement elements in order to pivotally fold said swing arm to move between said retracted position and said extended position.

3. The vehicle bumper, as recited in claim 2, wherein said swing arm, having telescopic configuration, comprises a first arm member having an upper end pivotally coupled at said mounting base, and a second arm member having a lower end extended to said step platform and defining said locking portion at an upper end of said second arm member, wherein said first arm member and said second arm member are slidably coupled with each other, such that when said second arm member is downwardly slid from said first arm member to downwardly move away from said mounting base, said locking portion of said second arm member is disengaged with one of said first and second engagement elements.

4. The vehicle bumper, as recited in claim 3, wherein said retractable step further comprises a first resilient element coupled between said first and second arm members for applying a pulling force between said first and second arm members so as to ensure said locking portion being engaged with one of said first and second engagement elements.

5. The vehicle bumper, as recited in claim 4, wherein said first resilient element comprises a compression spring having one end connecting to said first arm member and an opposed end connecting to said second arm member for pulling said first and second arm members toward each other.

6. The vehicle bumper, as recited in claim 3, said retractable step further comprises a second resilient element coupled between said mounting base and said first arm member for applying a pushing force to said swing arm to pivotally push said step member from said retracted position to said extended position when said swing member is disengaged with said first engagement element.

7. The vehicle bumper, as recited in claim 5, said retractable step further comprises a second resilient element coupled between said mounting base and said first arm member for applying a pushing force to said swing arm to pivotally push said step member from said retracted position to said extended position when said locking portion is disengaged with said first engagement element.

8. The vehicle bumper, as recited in claim 6, wherein said second resilient element comprises a coil spring having a coil portion coupled at a pivot point between said first arm member and said mounting base, and two arm portions biasing against said mounting base and said first arm member respectively for pushing said locking portion from said retracted position to said extended position.

9. The vehicle bumper, as recited in claim 7, wherein said second resilient element comprises a coil spring having a coil portion coupled at a pivot point between said first arm member and said mounting base, and two arm portions biasing against said mounting base and said first arm member respectively for pushing said swing arm from said retracted position to said extended position.

10. The vehicle bumper, as recited in claim 1, wherein said locking unit further comprises a foot actuator sidewardly extended from said step platform in order to disengage said locking portion of said swing arm from each of said first and second engagement elements and pivotally push said swing arm from said extended position to said retracted position.

11. The vehicle bumper, as recited in claim 7, wherein said locking unit further comprises a foot actuator sidewardly extended from said step platform in order to disengage said locking portion of said swing arm from each of said first and second engagement elements and pivotally push said swing arm from said extended position to said retracted position.

12. The vehicle bumper, as recited in claim 9, wherein said locking unit further comprises a foot actuator sidewardly extended from said step platform in order to disengage said locking portion of said swing arm from each of said first and second engagement elements and pivotally push said swing arm from said extended position to said retracted position.

13. The vehicle bumper, as recited in claim 11, wherein said foot actuator coupled at said lower end of said second arm member and arranged in such a manner that when said foot actuator is depressed, said second arm member is slid downwardly to disengage said locking portion with one of said first and second engagement elements.

14. The vehicle bumper, as recited in claim 12, wherein said foot actuator coupled at said lower end of said second arm member and arranged in such a manner that when said foot actuator is depressed, said second arm member is slid downwardly to disengage said locking portion with one of said first and second engagement elements.

15. The vehicle bumper, as recited in claim 13, wherein said foot actuator comprises a rear foot pressing platform coupled at said lower end of said second arm member and a front foot pushing platform pivotally coupled at a front edge of said rear foot pressing platform for pushing said step member from said extended position to said retracted position.

16. The vehicle bumper, as recited in claim 14, wherein said foot actuator comprises a rear foot pressing platform coupled at said lower end of said second arm member and a front foot pushing platform pivotally coupled at a front edge of said rear foot pressing platform for pushing said step member from said extended position to said retracted position.

17. The vehicle bumper, as recited in claim 1, wherein said first and second engagement elements are first and second engagement slots spacedly indented at a circumferential edge of said mounting base for engaging with said locking portion of said swing arm.

18. The vehicle bumper, as recited in claim 16, wherein said first and second engagement elements are first and second engagement slots spacedly indented at a circumferential edge of said mounting base for engaging with said locking portion of said swing arm.

19. The vehicle bumper, as recited in claim 17, wherein said locking portion of said swing arm is an engaging protrusion integrally extended from said swing arm to selectively engage with one of said first and second engagement slots.

20. The vehicle bumper, as recited in claim 18, wherein said locking portion of said swing arm is an engaging protrusion integrally extended from said swing arm to selectively engage with one of said first and second engagement slots.

21. The vehicle bumper, as recited in claim 18, wherein said mounting base comprises a U-shaped base member coupled at said bottom side of said bumper body to pivotally couple with said upper end of said swing arm, and a mounting plate supported in said base member to form said first and second engagement elements as said first and second engagement slots at a circumferential edge of said mounting plate.

22. The vehicle bumper, as recited in claim 20, wherein said mounting base comprises a U-shaped base member coupled at said bottom side of said bumper body to pivotally couple with said upper end of said swing arm, and a mounting plate supported in said base member to form said first and second engagement elements as said first and second engagement slots at a circumferential edge of said mounting plate.
